(19) United States
(12) Patent Application Publication
(10) Pub. No.: US 2006/0103761 A1
(43) Pub. Date: May 18, 2006

(54) Television apparatus and control method thereof

(75) Inventor: Jong-pill Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/272,835

(22) Filed: Nov. 15, 2005

(30) Foreign Application Priority Data
Nov. 15, 2004 (KR) 10-2004-0093257

(51) Int. Cl. H04N 3/27; H04N 5/46

(52) U.S. Cl. 348/558; 348/554

(57) ABSTRACT

A television apparatus with a tuner to select an RF broadcast signal received through an antenna and an associated method are disclosed. The television apparatus has a digital demodulator to receive a broadcast signal from the tuner and to demodulate the broadcast signal into a video signal corresponding to one among many different broadcasting systems on the basis of a predetermined control signal. The television apparatus also has a controller to determine the broadcasting system by sensing the broadcast signal received from the tuner and to control the digital demodulator to demodulate the broadcast signal into the video signal of the determined broadcasting system. Thus, the present invention provides a television apparatus and a control method thereof, in which a broadcasting system of a broadcast signal is determined and the broadcast signal is automatically demodulated to the determined broadcasting system, thereby reproducing the broadcast signal of various broadcasting systems.

### CROSS-REFERENCE TO RELATED APPLICATIONS

This application claims the benefit of Korean Patent Application No. 2004-0093257, filed on Nov. 15, 2004, in the Korean Intellectual Property Office, the disclosure of which is incorporated herein by reference.

### BACKGROUND OF THE INVENTION

1. Field of the Invention

The present invention relates to a television apparatus with a tuner to tune a radio frequency (RF) broadcast signal received through an antenna, and more particularly, to a television apparatus and a control method thereof, in which a broadcasting system of a broadcast signal is determined and the broadcast signal is automatically demodulated according to the determined broadcasting system, thereby reproducing the broadcast signal of various broadcasting systems.

2. Description of the Related Art

A broadcasting system used in various countries is classified into a national television system committee (NTSC) broadcasting system, a phase alternation line (PAL) broadcasting system, and a systems equential couleur a memoire (SECAM) broadcasting system according to color manners of a video signal. Each country in the world employs one of the foregoing broadcasting systems for broadcasting. For reference, Korea employs the NTSC broadcasting system.

Thus, a television apparatus is produced in accordance with the broadcasting system employed in each country, thereby receiving/reproducing the broadcast signal. Hereinbelow, configurations of a conventional television apparatus will be described with reference to FIG. 1.

The conventional television apparatus comprises a display part 6; an antenna 1 to receive an RF broadcast signal; a tuner 2 to select one of the RF broadcast signals received through the antenna 1 and convert it into an intermediate frequency (IF) broadcast signal; a demodulator 3 to demodulate the IF broadcast signal received from the tuner 2 into a predetermined composite video broadcast signal (CVBS); a video decoder 4 to decode the video signal outputted from the demodulator 3 into a digital video signal; a scaler 5 to convert the digital video signal outputted from the video decoder 4 into a proper format for the display part 6; a key input part 8 to allow a user to input a key; and a microcomputer 7 to control the tuner 2, the demodulator 3, the video decoder 4 and the scaler 5 to tune, convert, demodulate and decode the RF broadcast signal corresponding to a channel selected by the key input part 8. Here, a surface acoustic wave (SAW) filter (not shown) is interposed between the tuner 2 and the demodulator 3.

In a case where the conventional television is used in a country employing the PAL broadcasting system and having an output IF of 38.9 MHz, a 38.9 MHz/8 MHz SAW filter (not shown) is interposed between the tuner 2 and the demodulator 3. Thus, the tuner 2 is tuned to the RF broadcast signal by a control signal based on frequency obtained by mixing the real receiving RF and the output IF of 38.9 MHz. The tuner 2 converts the tuned RF broadcast signal into the IF broadcast signal, and the demodulator 3 demodulates the IF broadcast signal filtered through the SAW filter (not shown) into a predetermined CVBS on the basis of a demodulating algorithm according to the set PAL broadcasting system.

As described above, the conventional television apparatus processes the broadcast signal of only the broadcasting system (e.g., the PAL broadcasting system) set when it is produced. On the other hand, various broadcasting systems are employed in different countries, so that it is difficult to use the foregoing television apparatus to tune to other broadcasting systems (e.g., the NTSC broadcasting system). When a broadcasting system (e.g., PAL) has been set in a television apparatus, it is necessary to go through the inconvenience of replacing integrated chips (ICs) in the demodulator 3 and SAW filter (not shown) to enable the television apparatus to receive a broadcasting signal of another broadcasting system (e.g., the NTSC broadcasting system).

### SUMMARY OF THE INVENTION

Accordingly, it is an aspect of the present invention to provide a television apparatus and a control method thereof, in which a broadcasting system of a broadcast signal is determined and the broadcast signal is automatically demodulated according to the determined broadcasting systems, thereby reproducing the broadcast signal of various broadcasting systems.

The foregoing and/or other aspects of the present invention are also achieved by providing a television apparatus with a tuner to select an RF broadcast signal received through an antenna, comprising a digital demodulator to receive a broadcast signal from the tuner and demodulate the broadcast signal into a video signal corresponding to one among a plurality of different broadcasting systems on the basis of a predetermined control signal; and a controller to determine the broadcasting system by sensing the broadcast signal received from the tuner and control the digital demodulator to demodulate the broadcast signal into the video signal corresponding to the determined broadcasting system.

According to an aspect of the present invention, the digital demodulator comprises a selection filter to selectively pass one among a plurality of predetermined frequency band components of the broadcast signal received from the tuner; and a demodulating controller to control the selection filter to pass a predetermined frequency band component, among a plurality of predetermined frequency band components, of the broadcast signal corresponding to the broadcasting system on the basis of a control signal outputted from the controller.

According to an aspect of the present invention, the controller comprises a video decoder to determine the broadcasting system by sensing the broadcast signal received from the tuner, to control the digital demodulator to demodulate the broadcast signal into the video signal corresponding to the determined broadcasting system, and to convert the video signal outputted from the digital demodulator into a digital video signal.

According to an aspect of the present invention, the plurality of different broadcasting systems includes an NTSC broadcasting system, a PAL broadcasting system, and a SECAM broadcasting system.

The foregoing and/or other aspects of the present invention are also achieved by providing a method of controlling a television apparatus with a tuner to select an RF broadcast signal received through an antenna, the method comprising tuning for an RF broadcast signal corresponding to a selected broadcasting channel; determining a broadcasting system by sensing the broadcast signal received from the tuner; and demodulating the broadcast signal outputted from the tuner into a video signal corresponding to the determined broadcasting system among the plurality of different broadcasting systems.

According to an aspect of the present invention, the method further comprises providing a selection filter to selectively pass one among a plurality of predetermined frequency band components of the broadcast signal received from the tuner.

According to an aspect of the present invention, the demodulating the broadcast signal comprises controlling the selection filter to pass a predetermined frequency band component of the broadcast signal corresponding to the determined broadcasting system among the plurality of predetermined frequency band components of the broadcast signal received from the tuner.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a control block diagram of a conventional television apparatus;

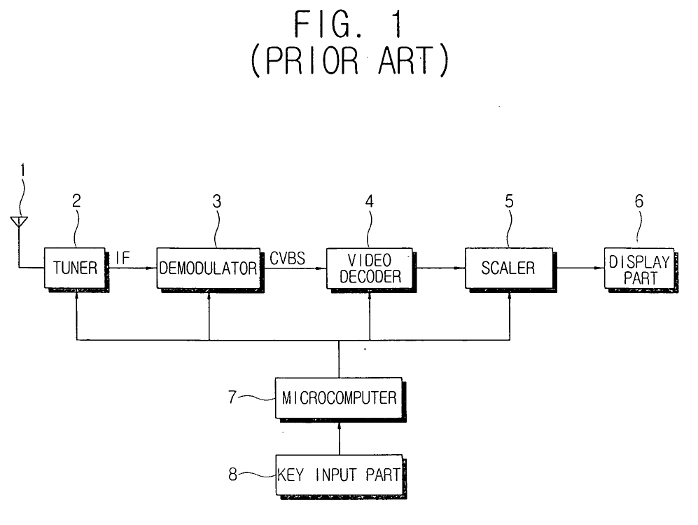

FIG. 2 is a control block diagram of a television apparatus according to an embodiment of the present invention; and

FIG. 3 is a control flowchart of the television apparatus according to an embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

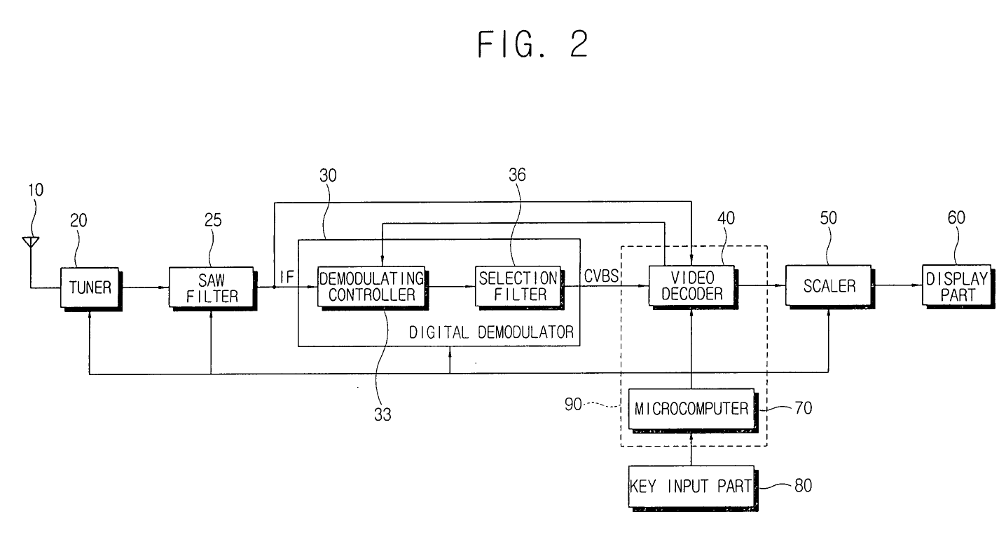

FIG. 2 is a control block diagram of a television apparatus according to an embodiment of the present invention. As shown therein, a television apparatus according to an embodiment of the present invention comprises a display part 60; an antenna 10 to receive an RF broadcast signal; a tuner 20 to select one of the RF signals received through the antenna 10; a SAW filter 25 to pass a predetermined frequency band component of the RF broadcast signal received through the antenna 10; and a digital demodulator 30 to be controlled by a controller 90 (to be described later) to demodulate an IF broadcasting signal passed through the SAW filter 25 into a CVBS corresponding to one of various broadcasting systems.

Further, the television apparatus according to an embodiment of the present invention comprises a video decoder 40 to decode a video signal outputted from the digital demodulator 30 into a digital video signal; a scaler 50 to convert the digital video signal outputted from the video decoder 40 to have a proper format for the display part 60; a key input part 80 to allow a user to input a key; and the controller 90 comprising the video decoder 40, determining the broadcasting system by sensing the IF broadcast signal passed through the SAW filter 25, and controlling the digital demodulator 30 to demodulate the IF broadcast signal into the CVBS corresponding to the determined broadcasting system.

The tuner 20 is used to select the RF broadcast signal received through the antenna 10. A real tuning frequency selected by the tuner 20 is obtained by a sum of an RF real frequency (i.e., the frequency of a selected channel) and an output IF frequency (i.e., the frequency of the SAW filter 25). Here, in a case that the SAW filter 25 has a parameter of 38.9 MHz/8 MHz for a PAL broadcasting system and the tuner 20 is tuned to a real channel corresponding to a frequency of 55.25 MHz, the real tuning frequency is as follows.
F_{OSC}=F_{RF}+F_{IF}→F_{OSC}=55.25 MHz+38.9 MHz, where
F_{OSC} is the real tuning frequency selected by the tuner 20;
F_{RF} is the frequency of a selected channel; and
F_{IF} is the frequency of the SAW filter 25, outputted as the intermediate frequency IF.

Further, in a case that the tuner 20 uses a 1-step of 62.5 KHz, tune data tuned by the Tuner 20 is as follows.

$$\frac{{F}_{OSC}}{62.5 KHz} = \frac{55.25 MHz}{62.5 KHz} + \frac{38.9 MHz}{62.5 KHz} = 884 + 622.4 = 1506.4$$

The SAW filter 25 receives the selected broadcast signal from the tuner 20 and passes a predetermined frequency band component of the broadcast signal, thereby outputting the IF broadcast signal to the digital demodulator 30. According to an embodiment of the present invention, the SAW filter 25 has a parameter of 38.9 MHz/8 MHz for the PAL broadcasting system. Here, the SAW filter 25 is interposed between the tuner 20 and the digital demodulator 30. Alternatively, the SAW filter 25 may be provided before the input terminal of the tuner 20, or after the output terminal of the digital demodulator 30.

The digital demodulator 30 is controlled by the video decoder 40 (to be described later) to demodulate the input IF broadcast signal into the CVBS corresponding to one among the plurality of different broadcasting systems, thereby outputting the CVBS to the video decoder 40. Here, the digital demodulator 30 comprises a selection filter 36 to selectively pass one of a plurality of predetermined frequency band components of the IF broadcast signal; and a demodulating controller 33 to control the selection filter 36 to pass a predetermined frequency band component of the IF broadcast signal corresponding to the broadcasting system on the basis of a control signal outputted from the video decoder 40.

Preferably, but not necessarily, the selection filter 36 includes a band pass filter, and the digital demodulator 30 uses a software program to change the frequency band to be filtered by the control of the video decoder 40. In the foregoing embodiment, the PAL broadcasting system is employed, so that the selection filter 36 passes a frequency band component of 8 MHz by the control of the demodulating controller 33.

The controller 90 comprises the video decoder 40 determining the broadcasting system by sensing the IF broadcast signal passed through the SAW filter 25 and controlling the demodulating controller 33 to demodulate the IF broadcast signal into the CVBS corresponding to the determined broadcasting system, and a microcomputer 70 controlling the tuner 20, the SAW filter 25, the digital demodulator 30, the video decoder 40 and the scaler 50 to select the RF broadcast signal corresponding to a channel tuned by the key input part 80, determine the broadcasting system by sensing the IF broadcast signal of the RF broadcast signal, demodulate the IF broadcast signal into the CVBS corresponding to the determined broadcasting system, and process the CVBS to be displayed as a picture on the display part 60.

The video decoder 40 converts the CVBS demodulated by the digital demodulator 30 into the digital video signal to be processed by the scaler 50 according o the corresponding broadcasting system. Further, the video decoder 40 determines the broadcasting system by sensing the IF broadcast signal passed through the SAW filter 25, and controls the demodulating controller 33 to demodulate the IF broadcast signal into the CVBS corresponding to the determined broadcasting system.

Here, the video decoder 40 senses the IF broadcast signal passed through the SAW filter 25 and thus determines whether the input broadcast signal is of the PAL broadcasting system, the NTSC broadcasting system, or the SECAM broadcasting system on the basis of a vertical frequency component, a color carrier component, etc. of the IF broadcast signal.

The key input part 80 is used as an information input unit allowing a user to input a key. Here, the key input part 80 may comprise a remote controller (not shown) provided with keys for keying operation of a user, and a photodetector (not shown) to receive a wireless key input signal from the remote controller. Alternatively, the key input part 80 may be directly provided in the television apparatus.

Let the conventional television apparatus comprising the SAW filter 25 having a parameter of 38.9 MHz/8 MHz for the PAL broadcasting system be moved to an area based on the NTSC broadcasting system. In this case, when the SAW filter 25 is replaced by the SAW filter having a parameter of 47.5 MHz/6 MHz for the NTSC broadcasting system and the tuner 20 is tuned to a real channel corresponding to a frequency of 55.25 MHz, the real tuning frequency is as follows.
F_{OSC}=F_{RF}+F_{IF}→F_{OSC}=55.25 MHz+45.74 MHz

Further, in a case that the tuner 20 uses a 1-step of 62.5 KHz, tune data tuned by the tuner 20 is as follows.

$$\frac{{F}_{OSC}}{62.5 KHz} = \frac{55.25 MHz}{62.5 KHz} + \frac{45.75 MHz}{62.5 KHz} = 884 + 732 = 1616$$

On the other hand, when the television apparatus according to an embodiment of the present invention comprising the SAW filter 25 having a parameter of 38.9 MHz/8 MHz for the PAL broadcasting system is moved to an area based on the NTSC broadcasting system, the tune data is tuned the same as that of the PAL broadcasting system without replacing the SAW filter 25.

$$\frac{{F}_{OSC}}{62.5 KHz} = \frac{55.25 MHz + 38.9 MHz}{62.5 KHz} + \frac{6.85 MHz}{62.5 KHz} = 1506.4 + 109.6 = 1616$$

That is, according to an embodiment of the present invention, 1506.4 (=the tune data of the PAL broadcasting system) obtained by subtracting 109.6 from the conventional tune data of 1616 is tuned. Thus, regardless of the broadcasting systems, and on the basis of the broadcasting system (e.g., PAL broadcasting system) set when the television apparatus is produced, the broadcast signal is tuned when the channel is changed. Thereafter, the video decoder 40 determines the broadcasting system through the IF broadcast signal passed through the SAW filter 25. When the video decoder 40 determines that the broadcast signal is of the NTSC broadcasting system on the basis of the vertical frequency component, the color carrier component, etc. of the IF broadcast signal, the video decoder 40 controls the demodulating controller 33 to pass the frequency band component corresponding to the NTSC broadcasting system. Then, the demodulating controller 33 controls the selection filter 36 to pass the frequency band component of 6 MHz by the control of the video decoder 40.

In the foregoing embodiment, the SAW filter 25 is initially set to have a parameter of 38.9 MHz/8 MHz, and the same output IF of 38.9 MHz is considered regardless the broadcasting systems, thereby tuning the channel of the same tune data. Alternatively, the SAW filter 25 may be initially set to have a parameter of 45.75 MHz/6 MHz, and the output IF of 45.75 MHz may be considered.

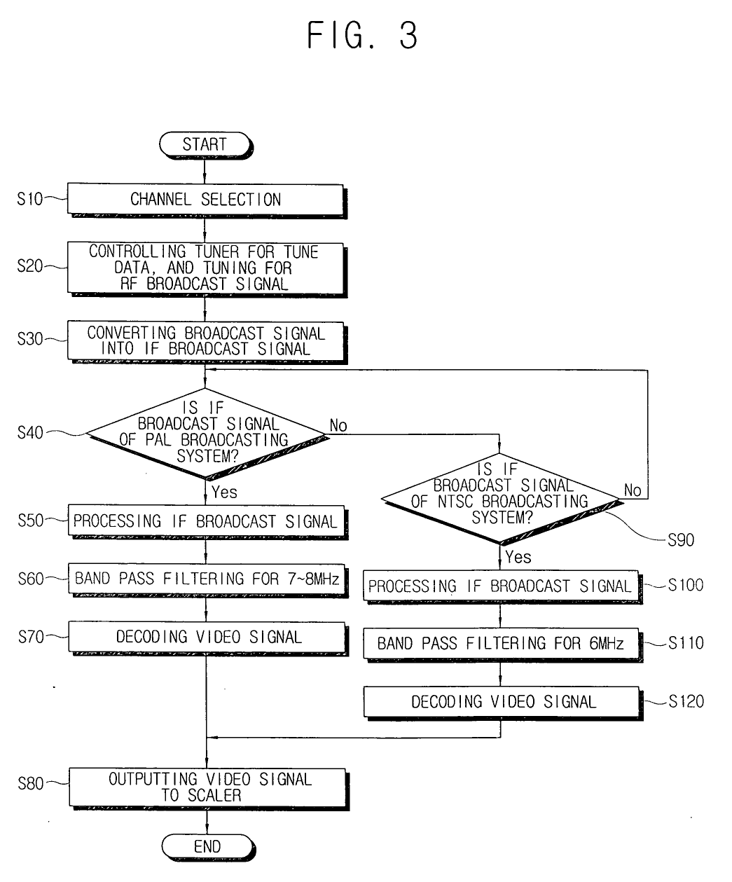

With this configuration, operation of the television apparatus according to an embodiment of the present invention will be described with reference to FIG. 3. Prior to the description, let the television apparatus comprising the SAW filter 25 having a parameter of 38.9 MHz/8 MHz be initially set for the PAL broadcasting system and be moved to an area employing the NTSC broadcasting system. Even though this embodiment describes the operation of the television apparatus using the PAL broadcasting system and the NTSC broadcasting system, the operation of the television apparatus is not limited to the two identified broadcasting systems, but can be employed for any broadcasting system. At operation S10, a user selects a channel of 55.25 MHz through the key input part 80. At operation S20, the tuner 20 is controlled by the microcomputer 70 to be tuned to the RF broadcast signal based on the previous tune data 1506.4. At operation S30, the RF broadcast signal is converted into the IF broadcast signal through the tuner 20 and the SAW filter 25. At operation S40, the video decoder 40 determines whether the broadcast signal is the PAL broadcasting system on the basis of the vertical frequency component, the color carrier component, etc. of the IF broadcast signal passed through the SAW filter 25. As a result of the determination, when the broadcast signal is not of the PAL broadcasting system, at operation S90, the video decoder 40 determines whether the broadcast signal is of the NTSC broadcasting system. As a result of the determination, when the broadcast signal is of the NTSC broadcasting system, at operation S100, the video decoder 40 outputs the control signal corresponding to the NTSC broadcasting system to the digital demodulator 30, and the digital demodulator 30 processes the IF broadcast signal of the NTSC broadcasting system. At operation S110, the demodulating controller 33 controls the selection filter 36 to pass the frequency band component of 6 MHz on the basis of the demodulating algorithm according to the NTSC broadcasting system. At operation S120, the video decoder 40 converts/decodes the video signal outputted from the digital demodulator 30 into the digital video signal to be processed by the scaler 50. At operation S80, the video decoder 40 outputs the digital video signal to the scaler 50. Thus, the digital video signal processed by the scaler 50 is displayed as a picture on the display part 60.

Therefore, in a case that the television apparatus receives the broadcast signal that is not from the initially set broadcasting system but another broadcasting system, RF broadcast signal having the same tune data as the other broadcasting system set in the tuner 20 is tuned when the channel is selected, without replacing the IC of the demodulator and the SAW filter 25. Further, the other broadcasting system of the input broadcast signal is determined, and the frequency band proper to the determined broadcasting system is filtered, thereby demodulating the IF broadcasting signal into a video signal proper to the determined broadcasting system.

In the meanwhile, as a result of the determination in the operation S40, when the IF broadcast signal is determined to be the PAL broadcasting system, in operation S50, the video decoder 40 outputs the control signal corresponding to the PAL broadcasting system to the digital demodulator 30, and the digital demodulator 30 processes the IF broadcast signal of the PAL broadcasting system. At operation S60, the demodulating controller 33 controls the selection filter 36, to pass the frequency band component of 8 MHz on the basis of the demodulating algorithm to the PAL broadcasting system. At operation S70, the video decoder 40 converts/decodes the video signal outputted from the digital demodulator 30 into the digital video signal to be processed by the scaler 50. At operation S80, the video decoder 40 outputs the digital video signal to one scaler 50.

Thus, in the television apparatus according to an embodiment of the present invention, a desired channel is tuned using the same SAW filter 25, the same output IF and the same tune data without replacing the SAW filter and the demodulating IC even though the broadcasting system is changed, and then the digital demodulator 30 demodulates/filters the broadcast signal into the video signal proper to the broadcasting system.

As described above, the present invention provides a television apparatus and a control method thereof, in which a broadcasting system of a broadcast signal is determined and the broadcast signal is automatically demodulated according to the determined broadcasting systems; thereby reproducing the broadcast signal of various broadcasting systems.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A television apparatus with a tuner to select an RF broadcast signal received through an antenna, comprising:
a digital demodulator to receive a broadcast signal from the tuner and demodulate the broadcast signal into a video signal corresponding to one among a plurality of different broadcasting systems on the basis of a predetermined control signal; and
a controller to determine the broadcasting system by sensing the broadcast signal received from the tuner and to control the digital demodulator to demodulate the broadcast signal into the video signal corresponding to the determined broadcasting system.

2. The television apparatus according to claim 1, wherein the digital demodulator comprises:
a selection filter to selectively pass one among a plurality of predetermined frequency band components of the broadcast signal received from the tuner; and
a demodulating controller to control the selection filter to pass a predetermined frequency band component of the broadcast signal corresponding to the broadcasting system on the basis of a control signal outputted from the controller.

3. The television apparatus according to claim 1, wherein the controller comprises a video decoder to determine the broadcasting system by sensing the broadcast signal received from the tuner, to control the digital demodulator to demodulate the broadcast signal into the video signal corresponding to the determined broadcasting system, and to convert the video signal outputted, from the digital demodulator into a digital video signal.

4. The television apparatus according to claim 3, wherein the plurality of different broadcasting systems includes an NTSC broadcasting system, a PAL broadcasting system, and a SECAM broadcasting system.

5. The television apparatus according to claim 2, wherein the controller comprises a video decoder to determine the broadcasting system by sensing the broadcast signal received from the tuner, to control the digital demodulator to demodulate the broadcast signal into the video signal corresponding to the determined broadcasting system, and to convert the video signal outputted from the digital demodulator into a digital video signal.

6. The television apparatus according to claim 5, wherein the plurality of different broadcasting systems includes an NTSC broadcasting system, a PAL broadcasting system, and a SECAM broadcasting system.

7. A method of controlling a television apparatus with a tuner to select an RF broadcast signal received through an antenna, the method comprising:
tuning for an RF broadcast signal corresponding to a selected broadcasting channel;
determining a broadcasting system by sensing the broadcast signal received from the tuner; and
demodulating the broadcast signal outputted from the tuner into a video signal corresponding to the determined broadcasting system among the plurality of different broadcasting systems.

8. The method according to claim 7, further comprising providing a selection filter to selectively pass one among a plurality of predetermined frequency band components of the broadcast signal received from the tuner.

9. The method according to claim 8, wherein the demodulating the broadcast signal comprises controlling the selection filter to pass a predetermined frequency band component of the broadcast signal corresponding to the determined broadcasting system among the plurality of predetermined frequency band components of the broadcast signal received from the tuner.

10. The method according to claim 9, wherein the plurality of different broadcasting systems includes an NTSC broadcasting system, a PAL broadcasting system, and a SECAM broadcasting system.
